(19) United States
(12) Patent Application Publication
(10) Pub. No.: US 2004/0139189 A1
(43) Pub. Date: Jul. 15, 2004

(54) Protocol based terminal authorities

(75) Inventor: Jari Vehmaa, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/751,888

(22) Filed: Jan. 7, 2004

Related U.S. Application Data
(63) Continuation of application No. PCT/FI02/00326, filed on Apr. 18, 2002.

(30) Foreign Application Priority Data
Jul. 11, 2001 (FI) 20011519

(51) Int. Cl. G06F 15/173; H04J 3/16; H04J 3/22

(52) U.S. Cl. 709/223; 370/469

(57) ABSTRACT

The present invention concerns a method for assigning a virtual terminal protocol specific terminal authority for a virtual terminal used to connect to a telecommunications network element in an MML session. According to the invention the virtual terminal protocols to be used to establish MML sessions between virtual terminals and telecommunications network elements are determined, a profile per each determined virtual terminal protocol is created, a virtual terminal protocol for a given virtual terminal is selected, a profile corresponding to the selected virtual terminal protocol is selected, and the virtual terminal is linked to the selected profile.

### FIELD OF THE INVENTION

The present invention relates to telecommunications. In particular, the present invention relates to a novel and improved method for assigning a virtual terminal protocol specific terminal authority for a virtual terminal used to connect to a telecommunications network element in an MML session.

### BACKGROUND OF THE INVENTION

MML (Man to Machine Language) commands are a generally implemented way to execute for example system administration tasks in digital telephone network systems. Typically a network operator employee or a user establishes an MML session from a terminal to a network element to be for example maintained or profiled, during which session said user enters various MML commands. Said MML commands are typically classified into various classes according to their functions. Finally the session is terminated.

Since the above scenario comprises serious safety risks (i.e. a single user could theoretically bring down a whole network either accidentally or on purpose), an authorization system has been implemented introducing the concepts of authorities and profiles.

Each user is assigned a user identification (user ID) and a password which must be entered in order to establish an MML session for entering MML commands.

Every MML command has a specific authority requirement, depending on how critical the command is to the system, or in other words, what kind of tasks can be carried out using the command. The authority requirement of an MML command determines the minimum authority which a given MML session must have in order for said MML command to reach the execution phase after being entered. Typical values for authority requirements of MML commands are for example 50, 100, 150, 200 and 250. If, for example, an MML command has an authority requirement of 50, it may be a command that can only be used to check the state of a system. If, for example, an MML command has an authority requirement of 250, it may be a very critical command that is used to significantly change the state of a system. It should be noted that the figures given above and elsewhere in this document are only meant as arbitrary examples and should not in any way be taken as limitations on the scope of the invention.

Each user ID as well as each terminal is assigned an authority. The authority of a given MML session is determined by checking the authorities of both the user ID and the terminal involved in said session and selecting the lower authority as the MML session authority. Thus, if the authority of a user ID is 150 and the authority of the terminal said user is utilizing is 250, the authority of the session will be 150. Thus, only MML commands of authority requirement of 150 or lower may be executed during the session.

Typically assigning authorities for a user ID and a terminal is accomplished by using profiles. A profile specifies authorities for each MML command class. Each user ID is linked to a profile thus defining its authorities per MML command class. Similarly each terminal is linked to a profile thus defining its authorities per MML command class. A given profile may be linked to several user IDs and/or terminals. Thus, for example, several user IDs may share a common profile and, accordingly, common authority data.

A commonly used terminal type is a so-called virtual terminal. The International Organization for Standardization (ISO) has defined a set of conventions defining a logical model for each class of terminals, called a virtual terminal, and a specification about how to drive this virtual terminal. A virtual terminal is a logical model in the sense that it defines an abstract model of a terminal in terms of logical functions that different real terminals can interpret.

There are various protocols designed to implement a virtual terminal. Probably the most widely used of these is the Telnet protocol which is a virtual terminal protocol in the Internet suite of protocols allowing users of one host to log into a remote host and act as normal terminal users of that host. The ISO Virtual Terminal (ISO VT) protocol is an application level service defined so that it functions on top of the OSI (Open Systems Interconnection) model. PAD (Packet Assembler/Disassembler) has been developed by ITU-T (Telecommunication Standardization Sector of the International Telecommunications Union) to connect an asynchronic terminal to a packet network.

However, there are some problems with using a virtual terminal in an MML session. Specifically, current implementations do no take into account the virtual terminal protocol used. For example, a given virtual terminal is assigned the same authority, whether it implements Telnet protocol or PAD protocol. Yet there may be significant differences in security features between various virtual terminal protocols. Therefore, for example, when using a virtual terminal protocol with limited security, a given virtual terminal should be assigned a low authority whereas, when using a virtual terminal protocol with high security, a given virtual terminal might be assigned a higher authority.

Thus, there is need for a way to determine terminal authorities for virtual terminals in MML sessions according to the virtual terminal protocol used.

### SUMMARY OF THE INVENTION

Consequently, the present invention concerns a method for assigning a virtual terminal protocol specific terminal authority for a virtual terminal used to connect to a telecommunications network element in an MML session.

According to the present invention the virtual terminal protocols to be used to establish MML sessions between virtual terminals and telecommunications network elements are determined. A profile per each determined virtual terminal protocol is created. A virtual terminal protocol for a given virtual terminal is selected. A profile corresponding to the selected virtual terminal protocol is selected. Finally the virtual terminal is linked to the selected profile.

In an embodiment of the invention each created profile specifies authorities per MML command class.

In an embodiment of the invention Telnet protocol is one of the virtual terminal protocols to be used to establish MML sessions.

In an embodiment of the invention PAD protocol is one of the virtual terminal protocols to be used to establish MML sessions.

In an embodiment of the invention ISO VT protocol is one of the virtual terminal protocols to be used to establish MML sessions.

The invention makes it possible to take into account the virtual terminal protocol used when establishing an MML session. Due to the invention it is possible to assign terminal authorities for virtual terminals used to connect to telecommunications network elements in MML sessions according to the virtual terminal protocol used. Thus the invention reduces safety risks associated with MML sessions since an MML session established using a relatively non-safe virtual terminal protocol can be assigned a lower authority than an MML session established using a relatively safe virtual terminal protocol.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow chart illustrating a method according to one embodiment of the present invention.

### DETAILED DESCRIPTION OF THE INVENTION

Reference will now be made in detail to the embodiments of the present invention, examples of which are illustrated in the accompanying drawings.

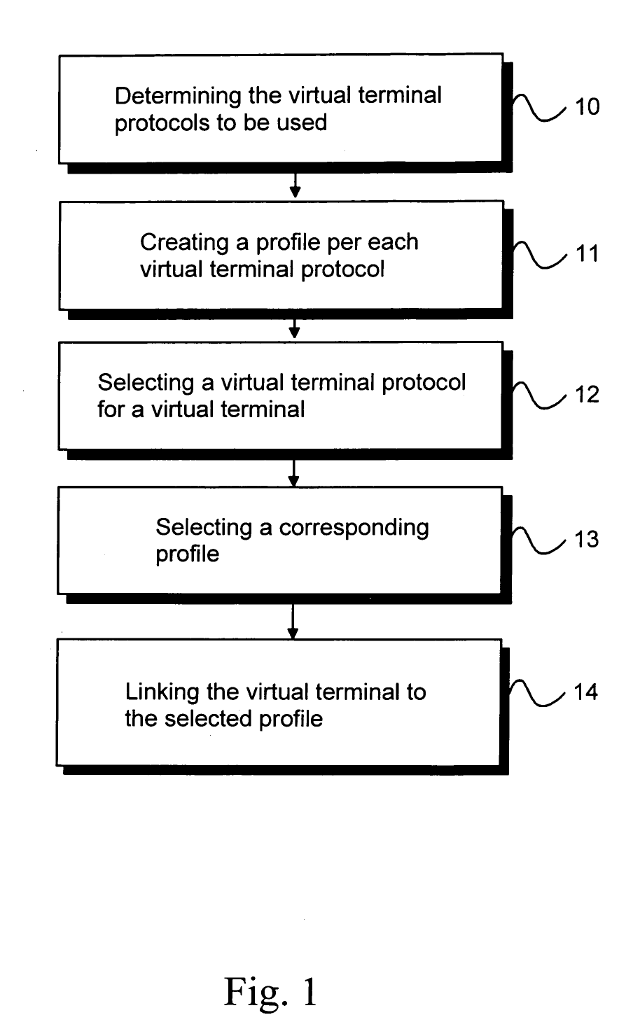

FIG. 1 illustrates a method for assigning a virtual terminal protocol specific terminal authority for a virtual terminal used to connect to a telecommunications network element in an MML session. Said telecommunications network element may be for example a local exchange, a mobile switching center, a call processing server, a media gateway or a service routing register.

The virtual terminal protocols to be used to establish MML sessions between virtual terminals and telecommunications network elements are determined, block 10. Examples of said virtual terminal protocols are Telnet protocol, PAD protocol and ISO VT protocol. A profile per each determined virtual terminal protocol is created, block 11. Each created profile specifies authorities per MML command class. A virtual terminal protocol for a given virtual terminal is selected, block 12. A profile corresponding to the selected virtual terminal protocol is selected, block 13. Finally, block 14, the virtual terminal is linked to the selected profile.

It is obvious to a person skilled in the art that with the advancement of technology, the basic idea of the invention may be implemented in various ways. The invention and its embodiments are thus not limited to the examples described above, instead they may vary within the scope of the claims.

1. A method for assigning a virtual terminal protocol specific terminal authority for a virtual terminal used to connect to a telecommunications network element in an MML session, characterized in that the method comprises the steps of:
determining the virtual terminal protocols to be used to establish MML sessions between virtual terminals and telecommunications network elements,
creating a profile per each determined virtual terminal protocol,
selecting a virtual terminal protocol for a given virtual terminal,
selecting a profile corresponding to the selected virtual terminal protocol, and
linking the virtual terminal to the selected profile.

2. The method as defined in claim 1, characterized in that each created profile specifies authorities per MML command class.

3. The method as defined in claims 1 or 2, characterized in that Telnet protocol is one of the virtual terminal protocols to be used to establish MML sessions.

4. The method as defined in claims 1, 2 or 3, characterized in that PAD protocol is one of the virtual terminal protocols to be used to establish MML sessions.

5. The method as defined in claims 1, 2, 3 or 4, characterized in that ISO VT protocol is one of the virtual terminal protocols to be used to establish MML sessions.
